(19) United States
(12) Patent Application Publication
(10) Pub. No.: US 2013/0064277 A1
(43) Pub. Date: Mar. 14, 2013

(54) Method, Apparatus and System for Antenna Calibration

(71) Applicants: Jingyi Liao, Solna (SE); Shaowei Yu, Beijing (CN); Zhiyi Zong, Beijing (CN)

(72) Inventors: Jingyi Liao, Solna (SE); Shaowei Yu, Beijing (CN); Zhiyi Zong, Beijing (CN)

(73) Assignee: TELEFONAKTIEBOLAGET LM ERICSSON (PUBL), Stockholm (SE)

(21) Appl. No.: 13/699,105

(22) PCT Filed: May 28, 2010
(86) PCT No.: PCT/CN2010/000764

§ 371 Date: Nov. 20, 2012

(51) Int. Cl. H04B 17/00

(52) U.S. Cl. 375/224

(57) ABSTRACT

The present invention discloses a method, an apparatus and a system for calibrating antenna, wherein channel transfer functions are obtained for subcarriers on at least one antenna to be calibrated and on a reference antenna, and the obtained channel transfer function of a first subcarrier is filtered by multiplying a symmetry filter with channel transfer functions of said first carrier's neighboring subcarriers, and the filtered channel transfer function is normalized; and a signal carried by the first subcarrier on the antenna to be calibrated is multiplied with the ratio of the filtered and normalized channel transfer function of the first subcarrier on said reference antenna to the filtered and normalized channel transfer function of said first subcarrier to get compensated. This enables to perform joint compensation on a subcarrier basis and thus reduce computation complexity.

### TECHNICAL FIELD

The present invention relates generally to the field of wireless communication, and particularly to a method, apparatus, and system for calibrating antenna.

### BACKGROUND

Multiple antennas with beamforming technology are adopted in Long Term Evolution (LTE) and LTE-Advanced (LTE-A) system in light of the requirements of high data rate. The bandwidth of ongoing LTE-Advanced system is significantly wider than that in previous wireless systems, such as LTE system. The scalable system bandwidth in LTE-Advanced system can exceed 20 MHz, potentially up to contiguous or non-contiguous 100 MHz. This makes it more difficult to ensure that the overall channel responses of RF chains of an eNodeB employed in LTE-Advanced system are close to ideal and do not introduce significant variations over frequencies of effective channels over the entire bandwidth. If this problem is not properly dealt with, the system may have to cope with a substantial increase of frequency-selectivity. This generally means amplitude/phase/group delay variation may change on different frequencies/subbands, and frequency-selectivity may have serious impacts on channel estimation quality as well as performance of beamforming or precoding. Antenna calibration is thus required for a digital beamforming system in different frequencies. Especially for a TD-LTE system, the antenna calibration across TX/RX chain of eNodeB is important for exploiting channel reciprocity. This asks for the antenna calibration on sub-bands, for example, compensation of the amplitude/phase/delay needs be done for individual subbands, especially in a wideband system.

In existing wireless system, delay is an important factor that will affect the performance of the system. Delays induced by cable length can be detected and calibrated by the Common Public Radio Interface (CPRI interface). However, it is not easy to detect delays in RF or IF components. Several methods were proposed for antenna calibration, but these methods do not show how to determine group delay caused by different subbands. Other methods discuss detection of group delay. One of them focuses on transmitting and receiving signal pattern that may meet a strict transmitting antenna calibration requirement, but this method does not come with a detail calibration process. Another one of them proposes to obtain antenna compensation parameters in terms of amplitude and (group) delay. However, all of these existing antenna calibration solutions employ same procedures, i.e. firstly obtaining antenna's multiple compensation parameters separately, then compensating antenna's amplitude and (group) delay by reshaping the obtained compensation parameters to their associated positions in time and (or) frequency grids.

Moreover, when delay compensation is done in time domain, a high over-sampling of normal transmitted signals is usually required to carry out a fractional delay compensation, in which the delay to be compensated is less than a sampling period. However, it is hard to implement such a high over-sampling in a wideband system. So, sometimes, a delay compensation, especially fractional delay compensation, may be done in frequency domain, this is particularly beneficial for systems employing Orthogonal Frequency Division Multiplexing (OFDM), since the compensation can be easily done before IFFT process. However, a single fractional delay will lead to a linear phase offset over each subcarrier, and then for each subcarrier, a redundancy exponential operation for compensating this phase offset will be necessary and the computation complexity will increase.

### SUMMARY

An object of the present invention is to provide an improved method, apparatus and system for calibrating antenna, which obviates at least some of the above-mentioned disadvantages.

According to a first aspect of the present invention, the present invention provides a method for calibrating antenna in a wireless system, said wireless system comprising at least one antenna to be calibrated and a reference antenna, and multiple subcarriers being allocated to each antenna, said method comprising the steps of: obtaining channel transfer functions for each subcarrier on said at least one antenna and on said reference antenna; filtering and normalizing the obtained channel transfer functions of respective subcarriers, where a symmetry filter being applied to performing said filtering; and multiplying a signal carried by a subcarrier on an antennae to be calibrated with the ratio of the filtered and normalized channel transfer function of corresponding subcarrier on said reference antenna to the filtered and normalized channel transfer function of said subcarrier to calibrate the signal.

Preferably, a 2N+1 odd order symmetric filter is chosen to filter the obtained estimated channel transfer function, where N is a non-negative integer.

Preferably, a 2N even order symmetric filter is chosen to filter the obtained estimated channel transfer function, where N is a positive integer.

Preferably, the step of obtaining comprising transmitting an antenna calibration training sequence, and the channel transfer function of each subcarrier is obtained in accordance with following formula:

$${H}_{i} ( k ) = \frac{{R}_{i} ( k )}{{S}_{i} ( k )} = {p}_{i}^{k} {e}^{j {ϕ}_{i}} {e}^{j k {δ}_{i}} + {N}_{i}^{′} ( k ) , \\ {δ}_{i} = 2 π {f}_{sub} Δ {t}_{fra} ,$$

where

Hᵢ(k) . . . Channel transfer function of subcarrier k of antenna i, where k is index of subcarrier and i is index of antenna;

Sᵢ(k) Transmitted antenna calibration training sequence on subcarrier k of antenna i in frequency domain;

Rᵢ(k) Received version of the antenna calibration training sequence Sᵢ(k) in frequency domain;

pᵢ^{k} Amplitude fading of antenna i;

φi Initial phase for antenna i;

Δt_{fra} Fractional time delay;

Nᵢ′(k) White noise on antenna i in frequency domain.

Preferably, the filtering is performed in accordance with following formula:

$${\tilde{H}}_{i} ( k ) = {\sum }_{l = - N}^{N} {w}_{l} {H}_{i} ( k + l ) , \\ M - N \geq k \geq N ;$$

$$Where$$

$${\sum }_{l = - N}^{N} {w}_{l} = 1$$

$$and$$

$${w}_{- l} = {w}_{l} ;$$

\tilde{H}ᵢ(k) The filtered channel transfer function for subcarrier k on antenna i;

wₗ Filtering weight of tap l of the symmetry filter;

M Number of neighboring subcarriers;

2N+1 Order of the symmetry filter.

Preferably, the filtering is performed in accordance with following formula:

$${\tilde{H}}_{i} ( k ) = {\sum }_{l = - N , l \neq 0}^{N} {w}_{l} {H}_{i} ( k + l ) , \\ M - N \geq k \geq N ;$$

$$where$$

$${\sum }_{l = - N , l \neq 0}^{N} {w}_{l} = 1$$

$$and$$

$${w}_{- l} = {w}_{l} ;$$

\tilde{H}ᵢ(k) The filtered channel transfer function for subcarrier k on antenna i;

wₗ Filtering weight of tap l of the symmetry filter;

M Number of neighboring subcarriers;

2N Order of the symmetry filter.

Preferably, the normalizing is performed in accordance with following formula:

$${C}_{i} ( k ) = {p}_{i}^{k} \frac{{\tilde{H}}_{i} ( k )}{\vert {\tilde{H}}_{i} ( k ) \vert} = {p}_{i}^{k} {e}^{j {ϕ}_{i}} {e}^{j k {δ}_{i}} ,$$

where

Cᵢ(k) The filtered and normalized channel transfer function for subcarrier k on antenna i;

\tilde{H}ᵢ(k) The filtered channel transfer function for subcarrier k on antenna i.

Preferably, the step of multiplying is performed in accordance with following formula:

$${\tilde{X}}_{i} ( k ) = \frac{{X}_{i} ( k )}{( \frac{{X}_{i} ( k )}{{X}_{ref} ( k )} )} = {X}_{i} ( k ) \frac{{C}_{ref} ( k )}{{C}_{i} ( k )} ,$$

where

C_{ref}(k) The filtered and normalized channel transfer function for subcarrier k on reference antenna;

Cᵢ(k) The filtered and normalized channel transfer function for subcarrier k on antenna i;

Xᵢ(k) Signal carried by subcarrier k on antenna i;

X_{ref}(k) Signal carried by subcarrier k on reference antenna;

\tilde{X}ᵢ(k) The compensated version of signal carried by subcarrier k on antenna i.

Preferably, amplitude fading pᵢ^{k} of subcarrier k on antenna i being obtained by averaging on the amplitudes of neighboring subcarriers of subcarrier k.

Preferably, the wireless system adopting OFDM, and one OFDM symbol being used for transmitting the antenna calibration training sequence.

According to a second aspect of the present invention, the present invention provides an apparatus for calibrating antenna in a wireless system, said wireless system comprising at least one antenna to be calibrated and a reference antenna, and multiple subcarriers being allocated to each antenna, said apparatus comprising: channel transfer function obtaining means for obtaining channel transfer functions for subcarriers on said at least one antenna and on said reference antenna, filtering and normalizing means for filtering and normalizing the obtained channel transfer functions of respective subcarriers, and comprising a symmetry filter for performing said filtering; and multiplying means for multiplying a signal carried by a subcarrier on an antennae to be calibrated with the ratio of the filtered and normalized channel transfer function of corresponding subcarrier on said reference antenna to the filtered and normalized channel transfer function of said subcarrier to calibrate the signal.

According to a third aspect of the present invention, the present invention provides a wireless system comprising an apparatus according to any one of claims 11-20, wherein said apparatus calibrating signals to be transmitted by a transmitter or signals received by a receiver.

Advantageously, by carrying out compensation on a subcarrier basis, simultaneous sub-bands calibration for a wideband system could be supported.

By jointly obtaining antenna calibration parameters and then carrying out antenna compensation, especially joint compensation of fractional time delay, initial phase, and amplitude fading, computation complexity is substantively reduced. Accordingly, it is not necessary to obtain the fractional time delay, initial phase separately, which will be a cumbersome process. Furthermore, it neither asks for an over-sampling solution in time domain for fractional time delay compensation processing, nor asks for a redundancy exponential operation for each subcarrier.

Advantageously, one OFDM symbol is enough for transmitting an antenna calibration training sequence, which is beneficial for a fast antenna calibration procedure.

### BRIEF DESCRIPTION OF THE DRAWINGS

The foregoing and other objects, features, and advantages of the present invention will become more apparent from the following description of preferred embodiments and accompany drawings.

FIG. 1 illustrates a flow chart of a process for performing antenna calibration according to an embodiment of the present invention.

FIG. 2 illustrates a block diagram of an apparatus for calibrating antenna according to an embodiment of the present invention.

FIG. 3 illustrates a block diagram of a wireless system comprising an apparatus for calibrating antenna according to an embodiment of the present invention.

### DETAILED DESCRIPTION

In the following description, for purposes of explanation rather than limitation, specific details, such as the particular architecture, interfaces, techniques, etc., are set forth for illustration. However, it will be apparent to those of ordinary skill in the art that other embodiments that depart from these specific details would still be understood to be within the scope of the present invention. Moreover, for the purpose of clarity, detailed descriptions of well-known devices, circuits, and methods are omitted so as not to obscure the description of the present invention. It should be expressly understood that the drawings are included for illustrative purposes and do not represent the scope of the present invention. In the accompanying drawings, like reference numbers in different drawings may designate similar elements.

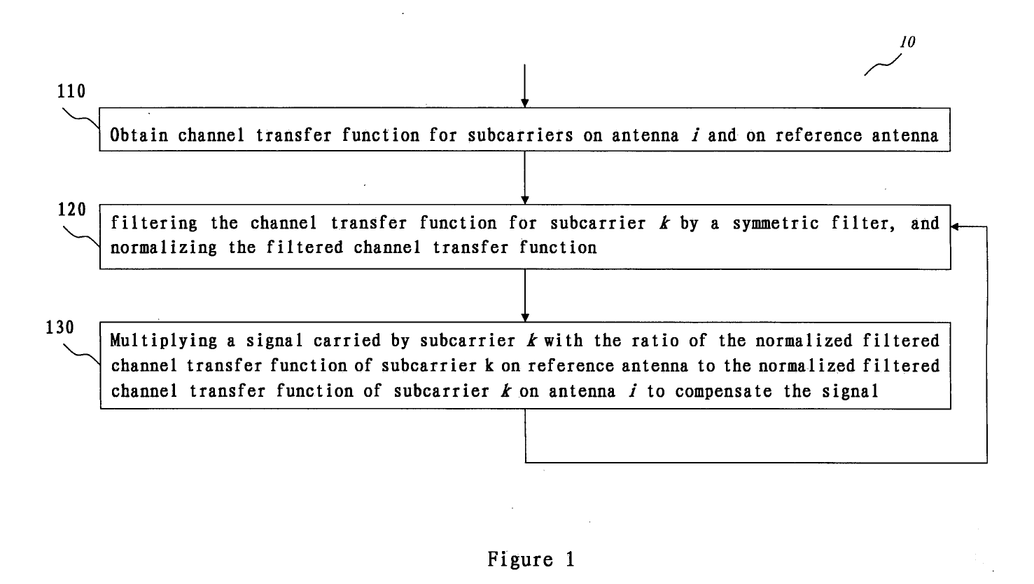

FIG. 1 illustrates a flow chart of a process 10 for performing antenna calibration in a wireless system according to an embodiment of the present invention.

The wireless system may be a wideband wireless system, such as a LTE-A system employing multi-input-multi-output (MIMO) and OFDM technology. The wireless system may comprise multiple antennas, to which a plurality of subcarriers are allocated.

When a signal sᵢ(t), for example, including an antenna calibration training sequence, is transmitted from a transmitter to a receiver in the wireless system, its corresponding received signal rᵢ(t) may be modeled as below:

rᵢ(t)=pᵢ^{k}e^{jφ}^{ᵢ}sᵢ(t−Δt)+nᵢ(t)

=pᵢ^{k}e^{j} ^{ᵢ}sᵢ[t−(Δtᵢₙₜ+Δt_{fra})]+nᵢ(t) i=1, . . . , I (1)

Where

i Index of antenna;

I The total number of antennas of the transmitter;

pᵢ^{k} Amplitude fading of antenna i;

φᵢ Initial phase for antenna i;

Δtᵢₙₜ Integer time delay, i.e. the delay is integer multiple of sampling period;

Δt_{fra} Fractional time delay;

nᵢ(t) White noise on antenna i.

The antenna calibration training sequence may be transmitted in one OFDM symbol. And antenna calibration training sequences may be discriminated by TDM/FDM (time domain multiplexing/frequency domain multiplexing), that is, different antenna specific sequences are allocated to different time or frequency grid, or by CDM (code domain multiplexing), that is, multiple antenna specific sequences are allocated to a same time or frequency grid, but these training sequences could be discriminated by their characteristic, e.g. their good auto-correlation and cross-correlation characteristics.

Since an antenna calibration training sequence will be known in advance by a receiver, the receiver will obtain both the transmitted signal sᵢ(t) and the received signal rᵢ(t). As such, both obtained signals are converted from time domain to frequency domain by e.g. DFT or FFT. For each subcarrier, the converted signals in frequency domain may be expressed as Sᵢ(k) and Rᵢ(k), k=1, . . . , K, here, k is index of subcarrier on antenna i and K is the number of subcarriers on antenna i.

When performing the conversion by e.g. DFT/FFT process, a phase rotation may be introduced as expressed in formula (2),

Rᵢ(k)=pᵢ^{k}e^{jφ}^{ᵢ}Sᵢ(k)e^{jkδ}^{ᵢ}+Nᵢ(k), δᵢ=2πf_{sub}Δt_{fra} (2).

where:

Nᵢ(k) White noise of subcarrier k on antenna i in frequency domain.

Then, as shown in FIG. 1, process 10 may include a step 110 for determining channel transfer function for all subcarriers on antennas based on the converted signals in frequency domain.

For example, the channel transfer function Hᵢ(k) for subcarrier k on antenna i of the transmitter is determined by formula (3):

$${H}_{i} ( k ) = \frac{{R}_{i} ( k )}{{S}_{i} ( k )} = {p}_{i}^{k} {e}^{j {ϕ}_{i}} {e}^{j k {δ}_{i}} + {N}_{i}^{′} ( k ) . \qquad ( 3 )$$

Process 10 may include a step 120 for filtering the determined channel transfer function Hᵢ(k) by using a symmetric filter and normalizing the filtered channel transfer function.

Preferably, the symmetric filter is a real symmetric filter, and its filter order may be odd or even. Alternatively, the symmetric filter may be an imaginary or a complex symmetry filter. White noise existing in the determined channel transfer function may be filtered out by the symmetric filter, since the filtering may be performed by averaging over several neighboring subcarriers. Reduction of the white noise, i.e. the filtering, may be written as in formula (4):

$${\tilde{H}}_{i} ( k ) = {\sum }_{l = - N}^{N} {w}_{l} {H}_{i} ( k + l ) , \\ M - N \geq k \leq N \qquad ( 4 )$$

Where M is the number of neighboring subcarriers, and wₗ is a filtering weight of tap l of the symmetric filter, with

$${\sum }_{l = - N}^{N} {w}_{l} = 1$$

and w₋ₗ=wₗ.

The symmetric filter here is a 2N+1 odd order symmetric filter.

According to another embodiment, reduction of the white noise, i.e. the filtering, may be written as in following formula:

$${\tilde{H}}_{i} ( k ) = {\sum }_{l = - N , l \neq 0}^{N} {w}_{l} {H}_{i} ( k + l ) , \\ M - N \geq k \geq N$$

Where wₗ is a filtering weight of tap l of the symmetric filter, with

$${\sum }_{l = - N , l \neq 0}^{N} {w}_{l} = 1 and {w}_{- l} = {w}_{l} .$$

The symmetric filter here is a 2N even order symmetric filter.

N may be a compromised value by taking the effects of both filtering of white noise and size of coherent frequency band into account. In a coherent frequency band, it is generally assumed that channel fading is flat and delays are approximately the same. The larger the value of N is taken, the closer the filtered channel transfer function \tilde{H}ᵢ(k) approaches to its expectation, i.e. white noise is completely filtered out. However, N need be chosen to make the e.g. 2N+1 or 2N neighboring subcarriers' channel fading flat.

When substituting formula (3) into formula (4), the filtered channel transfer function may be expressed as:

$${\tilde{H}}_{i} ( k ) = {p}_{i}^{k} {e}^{{jϕ}_{i}} {e}^{j k {δ}_{i}} {\sum }_{l = - N}^{N} {w}_{l} {e}^{j kl} = {p}_{i}^{k} {e}^{{jϕ}_{i}} {e}^{j k {δ}_{i}} [ 1 + 2 {\sum }_{l = 1}^{N} {w}_{l} cos ( {δ}_{i} l ) ] .$$

Then, the filtered channel transfer function \tilde{H}ᵢ(k) may be normalized to generate a joint compensation factor Cᵢ(k), which may be expressed as formula (5):

$${C}_{i} ( k ) = {p}_{i}^{k} \frac{{\tilde{H}}_{i} ( k )}{\vert {\tilde{H}}_{i} ( k ) \vert} = {p}_{i}^{k} {e}^{{jϕ}_{i}} {e}^{j k {δ}_{i}} . \qquad ( 5 )$$

Here, amplitude fading pᵢ^{k} of antenna i on subcarrier k may be easily obtained by averaging on amplitudes of neighboring subcarriers. Usually the amplitude fading is approximately the same for several continuous subcarriers (or called subband).

According to an embodiment, normalization can be done by choosing normalized filtering weights. Normalization can then be performed either before filtering, i.e. by selecting normalized filtering weights, to maintain the same powers of input/output signals. The length of the filtered and normalized channel transfer function equals to the order of the symmetry filter.

In this joint compensation factor Cᵢ(k), the effects of amplitude fading pᵢ^{k}, fractional time delay/offset Δt_{fra} and initial phase φᵢ are jointly implied. Hence, the determined compensation factor Cᵢ(k) can be directly used for antenna calibration in frequency domain without obtaining multiple calibration parameters, like fractional time delay, initial phase, separately.

When performing antenna calibration, a reference antenna may be assigned. A reference antenna may be an antenna to which an antenna to be calibrated will be compensated. According to an embodiment, one of the multiple antennas may be chosen as the reference antenna. Preferably, an antenna with a more stable and expected channel response is chosen as the reference antenna. According to another embodiment, if there is no a physical antenna satisfying the requirement of stable and expected channel response, a virtual perfect antenna with expected channel response may be assigned as the reference antenna.

Reference compensation factor C_{ref}(k) may be calculated for subcarrier k on a reference antenna. And antenna compensation factor Cᵢ(k) may also be calculated for subcarrier k on an antenna i to be calibrated.

As shown in FIG. 1, when reference compensation factor and antenna compensation factors are calculated, process 10 may include a step 130 for calibrating antenna i by multiplying the ratio of the reference compensation factor C_{ref}(k) for subcarrier k on reference antenna to antenna compensation factor Cᵢ(k) for subcarrier k on antenna i with a signal Xᵢ(k) transmitted by subcarrier k on antenna i. This calibration is to reshape e.g. fractional delay offset Δt_{fra}, initial phase shift φᵢ and amplitude fading pᵢ^{k}, so as to calibrate antenna i to obtain expected antenna outputs.

Here the signal Xᵢ(k) may be treated as received signal Rᵢ(k) with its white noise Nᵢ(k) removed. Then Xᵢ(k) may be expressed as:

Xᵢ(k)=pᵢ^{k}e^{jφ}^{ᵢ}Sᵢ(k)e^{jkδ}^{ᵢ}=Cᵢ(k)Sᵢ(k), δᵢ=2πf_{sub}Δt_{fra}.

Assuming that a reference signal X_{ref}(k) from the reference antenna will be a version of received signal Rᵢ(k) with its white noise removed, then X_{ref}(k)=p_{ref}^{k}e^{jφ}^{_{ref}}Sᵢ(k)e^{jkδ}^{_{ref}}=C_{ref}(k)Sᵢ(k), δ_{ref}=2πf_{sub}Δt_{fra}

The frequency domain joint antenna compensation of amplitude fading, initial phase and fractional time offset for subcarrier k on antenna i, M−N≧k≧N, can then be carried out according to formula (6):

$${\tilde{X}}_{i} ( k ) = \frac{{X}_{i} ( k )}{( \frac{{X}_{i} ( k )}{{X}_{ref} ( k )} )} = {X}_{i} ( k ) \frac{{C}_{ref} ( k )}{{C}_{i} ( k )} \qquad ( 6 )$$

The above compensation for each signal Xᵢ(k) transmitted by subcarrier k on antenna i makes Xᵢ(k) be compensated to the reference signal X_{ref}(k).

Note that since the filtering and antenna compensation may be based on e.g. 2N+1 neighboring subcarriers, this solution can inherently be suitable for compensation of group delay. And it is preferable that the variation of the phase shift difference between an antenna i under calibration and the reference antenna is less than ±π. If the difference of initial phase between an antenna i to be calibrated and the reference antenna is large, then pᵢ^{k}e^{jφ}^{ᵢ} that includes the effects of both amplitude fading and initial phase shift can be obtained by averaging on several complex neighboring subcarriers' signals in a coherent frequency band, the calibration formula (6) can be used for directly compensating fractional delay. The phase rotation incurred by the fractional delay after conversion from time domain to frequency domain can be within ±π.

In the above, only fractional delay is considered. However, integer delay may be obtained by maximum likelihood of repetition signals, e.g. the copy prefix part of original sequence.

In this case, the compensation is done by buffering RF signals up to an integer number of sampling period, which equals to the difference between integer delay of antenna under calibration and that of the reference antenna.

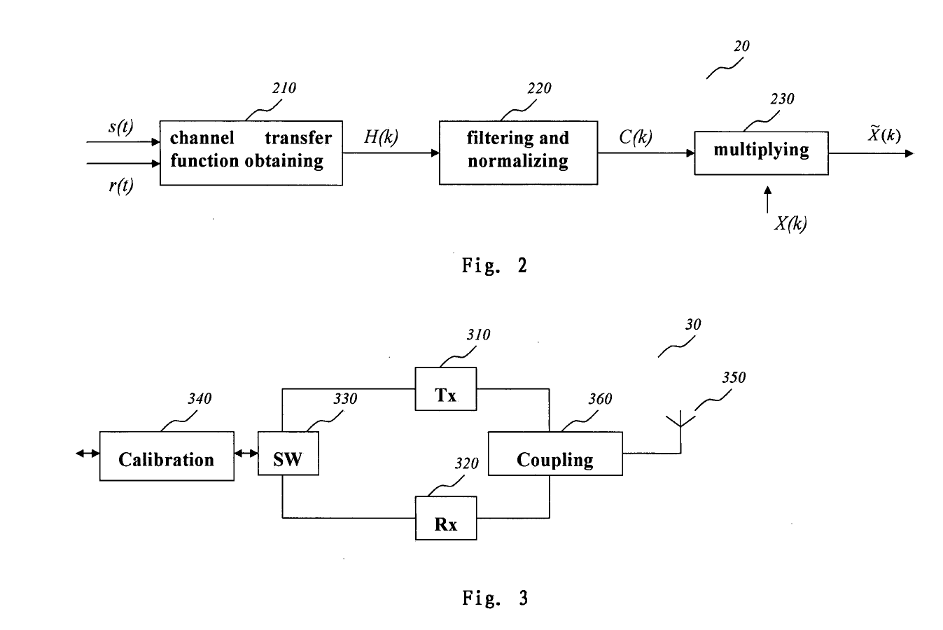

FIG. 2 shows a block diagram of an apparatus for calibrating antenna according to an embodiment of the present invention, in which the methods described above may be implemented.

As shown in FIG. 2, the apparatus or calibration unit 20 includes a channel transfer function obtaining module 210, a filtering and normalizing module 220 and a multiplying module 230.

Channel transfer function obtaining module 210 may obtain channel transfer function for subcarriers on antenna(s) to be calibrated and corresponding subcarriers on a reference antenna.

Channel transfer function obtaining module 210 may obtain an antenna calibration training sequence s(t) and its corresponding received training sequence r(t), and calculate a channel transfer function H(k) in dependence of the obtained training sequences. In doing so, according to an embodiment, the transmitted training sequence s(t) and the received training sequence r(t) may be converted to S(k) and R(k) in frequency domain by e.g. DFT or FFT, and then the channel transfer function H(k) is calculated as

$$\frac{R ( k )}{S ( k )} .$$

Filtering and normalizing module 220 may couple to channel transfer function obtaining module 210 to receive the calculated channel transfer function(s) H(k) there from. Filtering and normalizing module 220 may comprise a symmetric filter for filtering the obtained channel transfer function so as to remove white noise from H(k). The filtered channel transfer function(s) \tilde{H}(k) may then be normalized.

Filtering and normalizing module 220 may also include a variety of mechanisms for determining an amplitude fading p. For example, the amplitude fading p for a subcarrier on an antenna may be determined by averaging on the amplitudes of its neighboring subcarriers on the antenna. The amplitude fading p may multiply with the filtered and normalized channel transfer function as shown, for example, in formula (5) to get joint compensation factor(s) C(k).

Multiplying module 230 may couple to filtering and normalizing module 220 to receive at least an antenna compensation factor Cᵢ(k) for subcarrier k on antenna i and a reference compensation factor C_{ref}(k) for subcarrier k on reference antenna there from. Multiplying module 230 may perform antenna calibration by multiplying a signal transmitted by subcarrier k on antenna i with the ratio of the reference compensation factor C_{ref}(k) to the antenna compensation factor Cᵢ(k) to generate a compensated signal \tilde{X}(k).

With this calibration unit, it is not necessary to determine compensation parameters individually, a joint antenna compensation, including compensation for such as amplitude fading, initial phase and fractional delay, could be achieved. By normalizing filtered channel transfer function, fractional delay could be compensated in a simple and efficient way, and no exponential operation will be needed.

This calibration unit may be implemented in a wireless system, for compensating the effects of for example, amplitude fading, phase shift, delay etc. for signals transmitted by a transmitter or received by a receiver in this wireless system.

FIG. 3 illustrates a block diagram of a wireless system comprising a calibration unit according to an embodiment of the present invention.

The wireless system 30 is shown to include a transmitter 310, a receiver 320, a switch 330, and a calibration unit 340 according to an embodiment of the present invention.

The transmitter 310 and the receiver 320 couple to an antenna 350 through a coupling means 360 for transmitting signals or receiving signals via the antenna.

The transmitter 310 or the receiver 320 also couples to the calibration unit 340. When the calibration unit 340 couples to the transmitter 310, the calibration unit 340 may carry out antenna calibration on a subcarrier basis before a signal is transmitted by the transmitter 310. When the calibration unit 340 couples to the receiver 320, the calibration unit may carry out antenna calibration on a subcarrier basis after a signal is received by the receiver 320 from another transmitter. Preferably, the transceiver system comprises a switch 330, with which the calibration unit 340 may switch to either the transmitter 310 or the receiver 320 as needed.

As will be appreciated by one of skill in the art, the present invention may be embodied as a method, apparatus, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

The present invention has been described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

1-20. (canceled)

21. A method for calibrating at least one antenna in a wireless system, wherein the antenna has multiple subcarriers allocated to it and the method comprises:
obtaining a channel transfer function for each subcarrier with respect to the antenna, and obtaining a corresponding channel transfer function for the subcarrier with respect to a reference antenna in the wireless system;
filtering and normalizing the corresponding channel transfer functions, wherein the filtering is performed by applying a symmetry filter; and
calibrating a signal carried by the subcarrier on the antenna, based on multiplying the signal by a ratio, after said normalizing and filtering, of the corresponding channel transfer functions.

22. The method according to claim 21, wherein applying the symmetry filter to the corresponding channel transfer functions comprises using a 2N+1 odd order symmetry filter, where N is a non-negative integer.

23. The method according to claim 21, wherein applying the symmetry filter to the corresponding channel transfer functions comprises using a 2N even order symmetry filter, where N is a positive integer.

24. The method according to claim 21, wherein the obtaining each of the corresponding channel transfer functions is performed according to the following formula:
$${H}_{i} ( k ) = \frac{{R}_{i} ( k )}{{S}_{i} ( k )} = {p}_{i}^{k} {e}^{{jϕ}_{i}} {e}^{j k {δ}_{i}} + {N}_{i}^{′} ( k ) , {δ}_{i} = 2 π {f}_{sub} Δ {t}_{fra} ,$$
where
Hᵢ(k) is a channel transfer function of a subcarrier k of an antenna i, where k is an index of the subcarrier and i is an index of the antenna;
Sᵢ(k) is a transmitted antenna calibration training sequence on the subcarrier k of the antenna i in the frequency domain;
Rᵢ(k) is a received version of the antenna calibration training sequence Sᵢ(k) in the frequency domain;
pᵢ^{k} is an amplitude fading of the antenna i;
φᵢ is an initial phase for the antenna i;
Δt_{fra} is a fractional time delay; and
Nᵢ′(k) is a white noise on the antenna i in the frequency domain.

25. The method according to claim 24, wherein the filtering is performed in accordance with following formula:
$${\tilde{H}}_{i} ( k ) = {\sum }_{l = - N}^{N} {w}_{l} {H}_{i} ( k + l ) , M - N \geq k \geq N ;$$
$$where {\sum }_{l = - N}^{N} {w}_{l} = 1 and {w}_{- l} = {w}_{l} ;$$
\tilde{H}ᵢ(k) is a filtered channel transfer function for the subcarrier k on the antenna i;
wₗ is a filtering weight of tap l of the symmetry filter;
M is a number of neighboring subcarriers;
2N+1 is an order of the symmetry filter.

26. The method according to claim 24, wherein the filtering is performed in accordance with following formula:
$${\tilde{H}}_{i} ( k ) = {\sum }_{l = - N , l \neq 0}^{N} {w}_{l} {H}_{i} ( k + l ) , M - N \geq k \geq N ;$$
$$where {\sum }_{l = - N , l \neq 0}^{N} {w}_{l} = 1 and {w}_{- l} = {w}_{l} ;$$
\tilde{H}ᵢ(k) is the filtered channel transfer function for the subcarrier k on the antenna i;
wₗ is the filtering weight of tap l of the symmetry filter;
M is the number of neighboring subcarriers;
2N is the order of the symmetry filter.

27. The method according to claim 25, wherein the normalizing is performed in accordance with following formula:
$${C}_{i} ( k ) = {p}_{i}^{k} \frac{{\tilde{H}}_{i} ( k )}{\vert {\tilde{H}}_{i} ( k ) \vert} = {p}_{i}^{k} {e}^{{jϕ}_{i}} {e}^{j k {δ}_{i}} ,$$
where
Cᵢ(k) is a filtered and normalized channel transfer function for the subcarrier k on the antenna i;
\tilde{H}ᵢ(k) is a filtered channel transfer function for the subcarrier k on the antenna i.

28. The method according to claim 27, wherein the multiplying is performed in accordance with following formula:
$${\tilde{X}}_{i} ( k ) = \frac{{X}_{i} ( k )}{( \frac{{X}_{i} ( k )}{{X}_{ref} ( k )} )} = {X}_{i} ( k ) \frac{{C}_{ref} ( k )}{{C}_{i} ( k )} ,$$
where
C_{ref}(k) is a filtered and normalized channel transfer function for the subcarrier k on the reference antenna;
Cᵢ(k) is the filtered and normalized channel transfer function for the subcarrier k on the antenna i;
Xᵢ(k) is a signal carried by the subcarrier k on the antenna i;
X_{ref}(k) is a signal carried by the subcarrier k on the reference antenna;
\tilde{X}ᵢ(k) is a compensated version of the signal carried by the subcarrier k on the antenna i.

29. The method according to claim 24, wherein the amplitude fading pᵢ^{k} of the subcarrier k on the antenna i is obtained by averaging the amplitudes of neighboring subcarriers of the subcarrier k.

30. The method according to claim 24, wherein the wireless system employs OFDM, and at least one OFDM symbol is used for transmitting the antenna calibration training sequence.

31. An apparatus for calibrating an antenna in a wireless system, wherein the antenna has multiple subcarriers allocated to it and the apparatus comprises:
a device configured to obtain a channel transfer function for each subcarrier with respect to the antenna and a corresponding channel transfer function for the subcarrier with respect to a reference antenna included in the wireless system;
a device configured to filter and normalize the corresponding channel transfer functions, based in part on applying a symmetry filter; and
a device configured to calibrate a signal carried by the subcarrier on the antenna, based on multiplying the signal by a ratio of the filtered and normalized corresponding channel transfer functions.

32. The apparatus according to claim 31, wherein the symmetry filter comprises a 2N+1 odd order symmetry filter, where N is a non-negative integer.

33. The apparatus according to claim 31, wherein the symmetry filter comprises a 2N even order symmetry filter, where N is a positive integer.

34. The apparatus according to claim 31, wherein the device configured to obtain the corresponding channel transfer functions is configured to obtain the channel transfer function of each subcarrier in accordance with following formula:
$${H}_{i} ( k ) = \frac{{R}_{i} ( k )}{{S}_{i} ( k )} = {p}_{i}^{k} {e}^{{jϕ}_{i}} {e}^{j k {δ}_{i}} + {N}_{i}^{′} ( k ) , {δ}_{i} = 2 π {f}_{sub} Δ {t}_{fra} ,$$
where
Hᵢ(k) is a channel transfer function of a subcarrier k of an antenna i, where k is an index of the subcarrier and i is an index of the antenna;
Sᵢ(k) is a transmitted antenna calibration training sequence on the subcarrier k of the antenna i in the frequency domain;
Rᵢ(k) is a received version of the antenna calibration training sequence Sᵢ(k) in the frequency domain;
pᵢ^{k} is an amplitude fading of the antenna i;
φᵢ is an initial phase for the antenna i;
Δt_{fra} is a fractional time delay; and
Nᵢ′(k) is a white noise on the antenna i in the frequency domain.

35. The apparatus according to claim 34, wherein the device configured to filter and normalize the corresponding channel transfer functions is configured to perform the filtering in accordance with following formula:
$${\tilde{H}}_{i} ( k ) = {\sum }_{l = - N}^{N} {w}_{l} {H}_{i} ( k + l ) , M - N \geq k \geq N ;$$
$$Where {\sum }_{l = - N}^{N} {w}_{l} = 1 and {w}_{- l} = {w}_{l} ;$$
\tilde{H}ᵢ(k) is a filtered channel transfer function for the subcarrier k on the antenna i;
wₗ is a filtering weight of tap l of the symmetry filter;
M is a number of neighboring subcarriers;
2N+1 is an order of the symmetry filter.

36. The apparatus according to claim 34, wherein the device configured to filter and normalize the corresponding channel transfer functions is configured to perform the filtering in accordance with following formula:
$${\tilde{H}}_{i} ( k ) = {\sum }_{l = - N , l \neq 0}^{N} {w}_{l} {H}_{i} ( k + l ) , M - N \geq k \geq N ;$$
$$where {\sum }_{l = - N , l \neq 0}^{N} {w}_{l} = 1 and {w}_{- l} = {w}_{l} ;$$
\tilde{H}ᵢ(k) is the filtered channel transfer function for the subcarrier k on the antenna i;
wₗ is the filtering weight of tap l of the symmetry filter;
M is the number of neighboring subcarriers;
2N is the order of the symmetry filter.

37. The apparatus according to claim 35, wherein the device configured to filter and normalize the corresponding channel transfer functions is configured to perform the normalizing in accordance with following formula:
$${C}_{i} ( k ) = {p}_{i}^{k} \frac{{\tilde{H}}_{i} ( k )}{\vert {\tilde{H}}_{i} ( k ) \vert} = {p}_{i}^{k} {e}^{{jϕ}_{i}} {e}^{j k {δ}_{i}} ,$$
where
Cᵢ(k) is a filtered and normalized channel transfer function for the subcarrier k on the antenna i;
\tilde{H}ᵢ(k) is a filtered channel transfer function for the subcarrier k on the antenna i.

38. The apparatus according to claim 37, wherein the device configured to calibrate the signal carried by the subcarrier on the antenna is configured to perform the multiplying in accordance with following formula:
$${\tilde{X}}_{i} ( k ) = \frac{{X}_{i} ( k )}{( \frac{{X}_{i} ( k )}{{X}_{ref} ( k )} )} = {X}_{i} ( k ) \frac{{C}_{ref} ( k )}{{C}_{i} ( k )} ,$$
where
C_{ref}(k) is a filtered and normalized channel transfer function for the subcarrier k on the reference antenna;
Cᵢ(k) is the filtered and normalized channel transfer function for the subcarrier k on the antenna i;
Xᵢ(k) is a signal carried by the subcarrier k on the antenna i;
X_{ref}(k) is a signal carried by the subcarrier k on the reference antenna;
\tilde{X}ᵢ(k) is a compensated version of the signal carried by the subcarrier k on the antenna i.

39. The apparatus according to claim 34, wherein the device configured to obtain the corresponding channel transfer functions is configured to obtain the amplitude fading pᵢ^{k} of the subcarrier k on an antenna i by averaging the amplitudes of neighboring subcarriers of the subcarrier k.

40. The apparatus according to claim 34, wherein the wireless system is configured to recognize OFDM, and to use at least one OFDM symbol for transmitting the antenna calibration training sequence.
